(19) United States
(12) Patent Application Publication
(10) Pub. No.: US 2006/0034186 A1
(43) Pub. Date: Feb. 16, 2006

(54) Frame transmission method in wireless environment and system thereof

(75) Inventors: Young-sang Kim, Suwon-si (KR); Bong-geun Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/185,840

(22) Filed: Jul. 21, 2005

(30) Foreign Application Priority Data
Jul. 22, 2004 (KR) 2004-57151

(51) Int. Cl. H04L 12/26

(52) U.S. Cl. 370/252

(57) ABSTRACT

A frame transmission method performed by a transmitting end in a video reproduction system having the transmitting end for wirelessly transmitting frames and a receiving end for receiving the frames transmitted from the transmitting end and reproducing a video signal. The transmitting end receives information about a state of a wireless environment from the receiving end, determines the frames to be transmitted to the receiving end in consideration of the received information about the wireless environment state, and transmits the determined frames to the receiving end. The receiving end measures the state of the wireless environment by judging whether an error exists in the received frames and transmits the measured state of the wireless environment to the transmitting end. Accordingly, different frames can be transmitted according to the state of the wireless environment.

This application claims benefit under 35 U.S.C. § 119 from Korean Patent Application No. 2004-57151, filed on Jul. 22, 2004, the entire content of which is incorporated herein by reference.

### BACKGROUND OF THE INVENTION

1. Field of the Invention

The present invention relates to a video reproduction system for wirelessly transmitting transport streams composed of frames. More particularly, the present invention relates to a frame transmission method in a wireless environment and a video reproduction system thereof that can transmit different transport streams according to the state of the wireless environment.

2. Description of the Related Art

IEEE 802.11a describes a scheme for a transmitting-end's wireless transmission of transport streams to a receiving end, and particularly, it describes a method of transmitting a GOP (group of pictures) that constitutes a video signal. Generally, the GOP means a set of an inter-coded frame (I-frame), a predictive-coded frame (P-frame) and a bidirectionally predictive-coded frame (B-frame). Hereinafter, the I-frame, P-frame and B-frame will be explained in more detail.

As described above, according to the MPEG standard for the compression coding of a digital video signal, three types of frames, i.e., an I-frame, P-frame and B-frame, are considered. Particularly, the I-frame and B-frame have a high compression ratio by performing a motion-compensating prediction.

I-frame is coded without reference to other frames. The P-frame is coded with reference to the previous I-frame or P-frame. Since successive frames of a digital video signal have a high redundancy of color information, an effective compression coding of the digital video signal can be achieved by performing the motion information estimation and motion compensation prediction between the previous I-frame or P-frame and the present P-frame and then coding predicted errors and motion information.

The B-frame has the highest compression ratio, and the prediction thereof is performed with reference to the following I-frame or P-frame in addition to the previous I-frame or P-frame. The B-frame uses the motion compensation prediction in the same manner as the P-frame.

However, in coding the B-frame, two reference frames are used and a superior prediction performance is selected between the predictive performances obtained by the two reference frames, so that the B-frame has the highest compression ratio. Meanwhile, this B-frame is not used as the reference frame for other frames. I-picture and P-picture are called the reference frames.

Generally, a transmitting end of a video reproduction system transmits the I-frame, B-frame and P-frame to a receiving end thereof so that the receiving end can reproduce the corresponding video signal. The receiving end can receive all the frames transmitted from the transmitting end if the wireless environment is good. However, if the wireless environment is poor, the receiving end cannot normally receive the frames transmitted from the transmitting end. If the frames are not normally received, the receiving end cannot reproduce the video signal. That is, a scheme for normally reproducing a video signal even if a signal interference or overload occurs due to a poor wireless environment is required.

### SUMMARY OF THE INVENTION

The present invention has been developed in order to solve the above drawbacks and other problems associated with the conventional arrangement. An aspect of the present invention is to provide a video reproduction system and method that can normally reproduce a video signal even in a poor wireless environment.

Another aspect of the present invention is to provide a video reproduction system and method that can adjust the amount of transmitted data according to the state of a wireless environment.

The foregoing and other objects and advantages are substantially realized by providing a frame transmission method performed by a transmitting end in a video reproduction system having the transmitting end for wirelessly transmitting frames and a receiving end for receiving the frames transmitted from the transmitting end and reproducing a video signal, according to the present invention, which comprises the steps of receiving information about a state of a wireless environment from the receiving end, determining the frames to be transmitted to the receiving end in consideration of the received information about the wireless environment state, and transmitting the determined frames to the receiving end.

In another aspect of the present invention, there is provided a video reproduction method performed by a receiving end using received frames in a video reproduction system having a transmitting end for wirelessly transmitting the frames and the receiving end for receiving the frames transmitted from the transmitting end and reproducing a video signal, which comprises the steps of receiving the frames from the transmitting end, measuring a state of a wireless environment by judging whether an error exists in the received frames and reproducing the video signal using the received frames, and transmitting the measured state of the wireless environment to the transmitting end.

In still another aspect of the present invention, there is provided a video reproduction system having a transmitting end for wirelessly transmitting frames and a receiving end for receiving the frames transmitted from the transmitting end and reproducing a video signal, which comprises a control unit for determining the frames to be transmitted to the receiving end in consideration of information about a state of a wireless environment from the receiving end, an encoder for generating the frames to be transmitted in accordance with a control command from the control unit, and a wireless transmission module for wirelessly transmitting the generated frames.

In still another aspect of the present invention, there is provided a video reproduction system having a transmitting end for wirelessly transmitting frames and a receiving end for receiving the frames transmitted from the transmitting end and reproducing a video signal, which comprises a wireless reception module for receiving the frames from the transmitting end, a wireless environment measurement unit for measuring a state of a wireless environment by judging whether an error exists in the received frames, a decoder for reproducing the video signal using the received frames, and a control unit for transmitting the measured state of the wireless environment to the transmitting end.

### BRIEF DESCRIPTION OF THE DRAWINGS

The above aspects and features of the present invention will be more apparent by describing certain embodiments of the present invention with reference to the accompanying drawings, in which:

FIG. 1 is a view illustrating the construction of transmitting/receiving ends in a video reproduction system according to the present invention;

FIG. 2 is a view illustrating the operation performed by a receiving end in a video reproduction system according to the present invention;

FIG. 3 is a view illustrating the operation performed by a transmitting end in a video reproduction system according to the present invention; and

FIG. 4 is a view illustrating the operation performed by a receiving end in a video reproduction system according to the present invention.

### DETAILED DESCRIPTION OF THE EXEMPLARY EMBODIMENTS

Certain embodiments of the present invention will be described in greater detail with reference to the accompanying drawings.

In the following description, same drawing reference numerals are used for the same elements even in different drawings. The matters defined in the description such as in the detailed construction and elements are nothing but the ones provided to assist in a comprehensive understanding of the invention. Thus, it is apparent that the present invention may be carried out without those defined matters. Also, well-known functions or constructions are not described in detail since they would obscure the invention in unnecessary detail.

The present invention proposes a scheme for transmitting different transport streams according to the state of a wireless environment. According to the present invention, in a good wireless environment, an I-frame, B-frame and P-frame are transmitted, while in a poor wireless environment, only the I-frame is transmitted. Additionally, either the B-frame or P-frame may be transmitted along with the I-frame according to the state of the wireless environment.

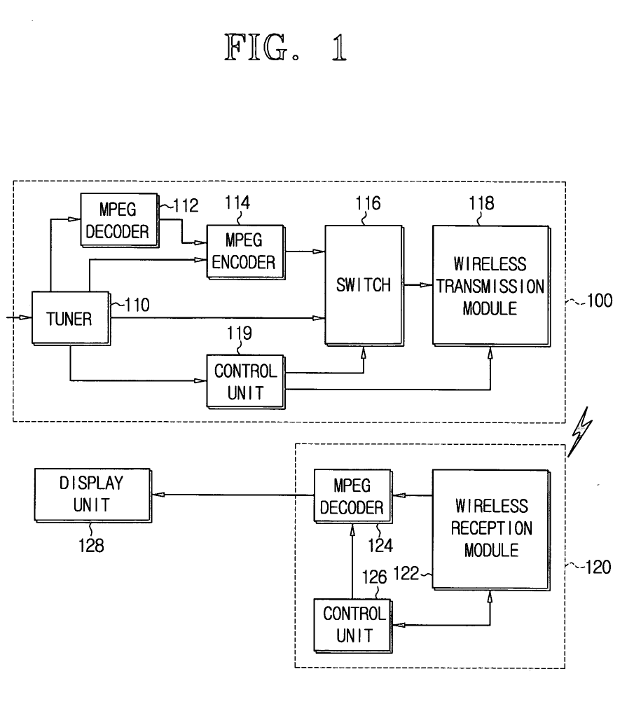

FIG. 1 is a view illustrating the construction of transmitting/receiving ends in a video reproduction system according to the present invention.

Referring to FIG. 1, a transmitting end 100 includes a tuner 110, an MPEG decoder 112, an MPEG encoder 114, a switch 116, a wireless transmission module 118 and a control unit 119. A receiving end 120 includes a wireless reception module 122, an MPEG decoder 124 and a control unit 126. Additionally, the video preproduction system further includes a display unit 128 for reproducing and displaying a video signal received by the receiving end 120.

The transmitting/receiving ends of the video reproduction system may include other constituent elements in addition to the above-described constituent elements, but explanation will be made with respect to the above-described constituent elements only for convenience in explanation.

The tuner 110, which is used in an input unit of a wireless receiving device, selects and extracts a specified radio wave (or an electric signal) by tuning the frequency of the specified radio wave (or electric signal). In relation to the present invention, the tuner 110 can extract an analog signal or a digital signal.

If the extracted signal is the analog signal, the tuner 110 transfers the signal to the MPEG encoder 114, while if the extracted signal is the digital signal, it transfers the signal to the MPEG decoder 112 or the switch 116 according to the channel environment. The MPEG decoder 112 performs a decoding process of the digital signal transferred from the tuner 110. The MPEG decoder 112 outputs a CVBS (Composite Video Banking Sync) signal through the decoding process. The CVBS signal is a kind of analog signal.

The CVBS signal is transferred to the MPEG encoder 114. The MPEG encoder 114 performs an encoding process of the input analog signal. Also, the MPEG encoder 114 generates frames according to the wireless environment. That is, if the wireless environment is good, it generates an I-frame, B-frame and P-frame, while if the wireless environment is poor, it generates an I-frame only. However, the frames generated by the MPEG encoder 114 may be changed according to a user's setting. That is, the MPEG encoder 114 may generate the I-frame, B-frame and P-frame, and transfer only a part of the generated frames according to the wireless environment. If the wireless environment is good, the MPEG encoder transfers the I-frame, B-frame and P-frame, while if the wireless environment is poor, it transfers only the I-frame.

The MPEG encoder 114 transfers the generated frames to the switch 116. The switch 116 performs a switching operation according to a control command. If the received signal is the analog signal, the switch 116 outputs the frames transferred from the MPEG encoder 114. Specifically, if the received signal is the digital signal and the channel environment is good, the switch 116 outputs the frames transferred from the tuner 110. If the received signal is the digital signal and the channel environment is poor, the switch 116 outputs the frames transferred from the MPEG encoder 114. Although FIG. 1 illustrates that the switch 116 receives the digital signal from the tuner 110 and the MPEG decoder 114, it may be set differently by a user. Specifically, in order to simplify the construction of the transmitting end 100, if the extracted signal is the analog signal, the tuner 110 transfers the signal to the MPEG encoder 114, while if the extracted signal is the digital signal, it transfers the signal to the MPEG decoder 112. In this case, the switch 116 receives the frames only from the MPEG encoder 114.

The switch 116 transfers the received frames to the wireless transmission module 118. The wireless transmission module 118 processes the received frames according to the control command, and then wirelessly transmits the processed frames. Since the operation of the wireless transmission module 118 is not related to the present invention, the detailed explanation thereof will be omitted. The control unit 119 controls the elements that constitute the transmitting end 100. Additionally, the control unit 119 determines the kind of frames to be generated by the MPEG encoder using information about the wireless environment being transferred from the receiving end 120.

Hereinafter, the construction of the receiving end 120 will be explained. The wireless reception module 122 processes the frames transferred from the wireless transmission module 118 according to the control command. Since the operation of the wireless reception module 122 is not related to the present invention, the detailed explanation thereof will be omitted. However, the wireless reception module 122 performs an operation that is opposite to the operation of the wireless transmission module 118. The wireless reception module 122 transfers the processed frames to the MEPG decoder 124.

The MPEG decoder 124 decodes the frames transferred from the wireless reception module 122 to convert the frames into an RGB form. The MPEG decoder 124 transfers the analog signal converted into the RGB form to the display unit 128. The control unit 126 controls the constituent elements that constitute the receiving end 120.

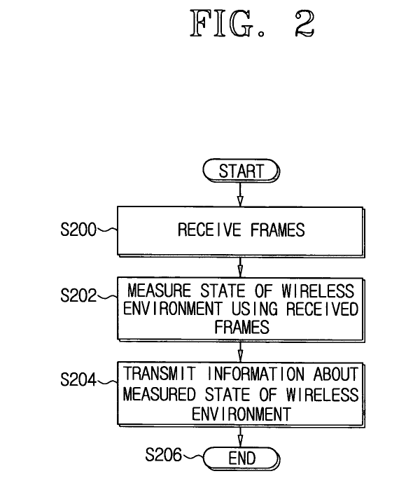

In relation to the present invention, the control unit 126 measures the state of the wireless environment using the frames transferred from the wireless reception module 122. That is, the control unit 126 measures whether the wireless environment is good or poor using the transferred frames. Although FIG. 1 illustrates that the control unit 126 measures the state of the wireless environment, it may be set differently by the user. Specifically, a wireless environment measurement unit (not illustrated) measures the state of the wireless environment in which the frames are received according to the control command of the control unit 126. The wireless environment measurement unit transfers the measured state of the wireless environment to the control unit 126. A method of measuring the state of the wireless environment that is performed by the receiving end will be explained with reference to FIG. 2. The control unit 126 transmits information about the measured wireless environment to the transmitting end.

The display unit 128 reproduces and displays the video signal using the analog signal transferred from the MPEG decoder 124. In the event that the analog signal includes a sound signal, this sound signal is also reproduced using a sound reproduction device.

FIG. 2 illustrates the operation performed by the receiving end according to the present invention. The operation of the receiving end will now be explained with reference to FIG. 2.

At step S200, the receiving end receives at least one frame. As described above, the receiving end may receive the I-frame, the I-frame and the B-frame, the I-frame and the P-frame, or the I-frame, and the B-frame and the P-frame. The receiving end reproduces the video signal using the received frames as shown in FIG. 1, and measures the state of the wireless environment using the received frames as shown in FIG. 2.

At step S202, the receiving end measures the state of the wireless environment using the received frames. That is, the receiving end measures the state of the wireless environment using whether any interference occurs among the received frames and whether any overload occurs in the wireless environment.

At step S204, the receiving end transmits the information about the measured state of the wireless environment to the transmitting end. The receiving end can transmit the information about the wireless environment state in diverse methods.

First method is for the receiving end to transmit the information about the measured wireless environment state as it is. It is assumed that the state of the wireless environment that can be measured by the receiving end is classified into states a through h. The state a denotes the best wireless environment state, and the state h denotes the worst wireless environment state. If the wireless environment state measured by the receiving end is the state a, the receiving end transmits the state a to the transmitting end. If the wireless environment state measured by the receiving end is the state d, the receiving end transmits the state d to the transmitting end. If the wireless environment state measured by the receiving end is the state h, the receiving end transmits the state h to the transmitting end.

Second method is for the receiving end to divide the measurable state of the wireless environment into at least two sections. In relation to the present invention, the receiving end divides the measurable state of the wireless environment into four sections. That is, the receiving end divides the measurable state of the wireless environment into four sections in consideration of the number of cases in which the transmitting end can transmit the frames. Hereinafter, an example of dividing the measurable state of the wireless environment into four sections will be explained using Table 1 below.

TABLE 1

| State of Wireless | Information Corresponding to | Frames Required to Be |
|---|---|---|
| Environment | State of Wireless Environment | Transmitted |
| a, b | A | I, B, P Frames |
| c, d | B | I, B Frames |
| e, f | C | I, P Frames |
| g, h | D | I Frame |

As described in Table 1, by dividing the measurable state of the wireless environment into four sections, the receiving end can transmit the state of the wireless environment using a smaller number of bits. Specifically, three bits are required to transmit the state of the wireless environment in the event that the state of the wireless environment is divided into the states a to h, but only two bits are required in the event that the state of the wireless environment is divided into four sections A to D. Hereinafter, for convenience in explanation, the states a to h refer to first information and the sections A to D refer to second information. As described above, by transmitting the second information, the transmitting end can determine the frames to be transmitted using the received second information only. Accordingly, by performing the above-described process, the load of the transmitting end can be reduced. In addition to the above-described methods, the receiving end can transmit the state of the wireless environment to the transmitting end by diverse methods.

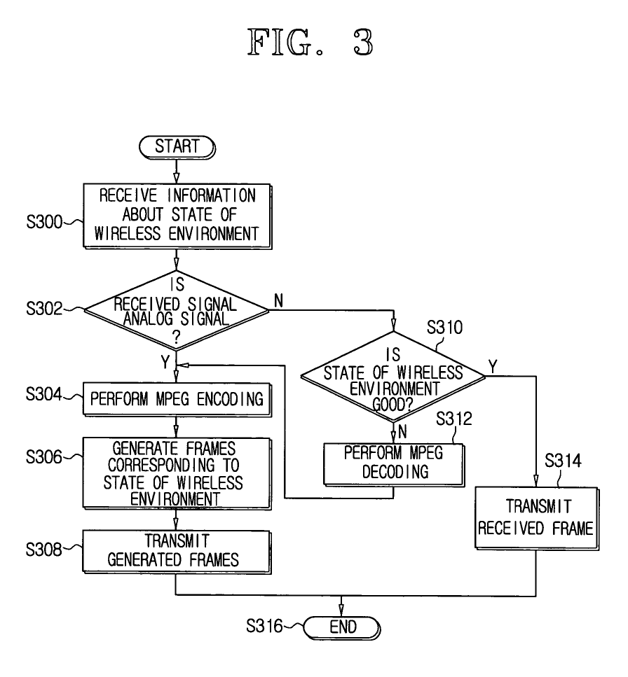

FIG. 3 illustrates the operation performed by the transmitting end in the video reproduction system according to the present invention. The operation of the transmitting end will now be explained with reference to FIG. 3.

At step S300, the transmitting end receives the information about the wireless environment. As described above, the transmitting end receives the first information or the second information.

At step S302, the transmitting end judges whether the received signal is the analog signal. If the received signal is the analog signal as a result of judgment, the transmitting end proceeds to step S304, while if the received signal is the digital signal, the transmitting end proceeds to step S310.

At step S310, the transmitting end judges whether the state of the wireless environment received at step S300 is good. In relation to the present invention, it is assumed that the good wireless environment state corresponds to the states a and b or the section A. If the wireless environment state is good as a result of judgment, the transmitting end proceeds to step S314, while if the wireless environment state is poor, the transmitting end proceeds to step S312.

At step S312, the transmitting end performs an MPEG decoding, and through this MPEG decoding, the digital signal is converted into the analog signal. If the conversion process is completed, the transmitting end proceeds to step S304.

At step S304, the transmitting end performs an MPEG encoding. If the encoding is completed, the transmitting end proceeds to step S306. At step S306, the transmitting end generates frames corresponding to the wireless environment state. The frames corresponding to the wireless environment state are shown in Table 1. If the wireless environment is good, the transmitting end generates the I-frame, B-frame and P-frame, and if the wireless environment is poor, it generates the I-frames only. If the frame generation is completed, the transmitting end proceeds to step S308.

At step S308, the transmitting end transmits the generated frames to the receiving end. Although in order to wirelessly transmit the generated frames, a specified process should be performed, it is not related to the present invention, and the detailed explanation thereof will be omitted.

At step S314, the transmitting end transmits the received digital signal (i.e., frames) to the receiving end.

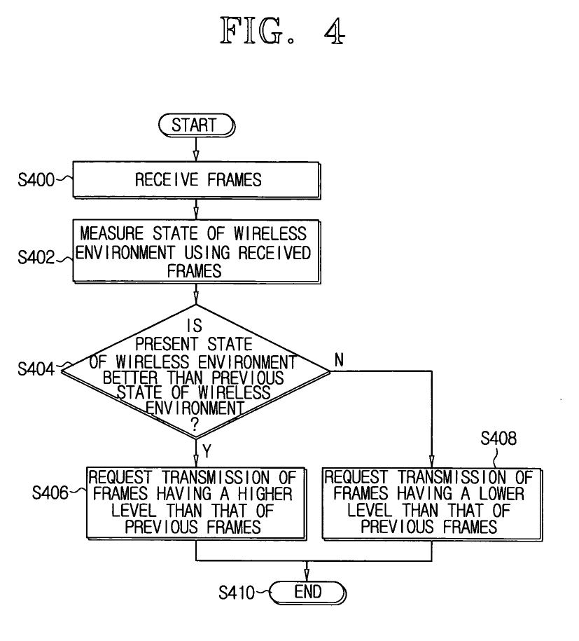

FIG. 4 is a view illustrating the operation performed by the receiving end in the video reproduction system according to the present invention.

At step S400, the receiving end receives at least one frame. The detailed operation performed at step S400 is equal to that performed at step S200.

At step S402, the receiving end measures the state of the wireless environment using the received frames. That is, the receiving end measures the state of the wireless environment using whether any interference occurs among the received frames or whether any overload occurs in the wireless environment.

At step S404, the receiving end compares the wireless environment state measured at step S402 with the wireless environment state previously measured. In order to compare the wireless environment states, the receiving end may have a memory of a specified capacity. If the wireless environment state presently measured is good as a result of comparison, the receiving end proceeds to step S406, while if the wireless environment state previously measured is good, the receiving end proceeds to step S408.

At step S406, the receiving end requests the transmitting end to transmit frames that are higher than the previously received frames by one level. Referring to Table 1, it is assumed that the transmitting end has transmitted the I-frame and B-frame. If the receiving end requests the transmitting end to transmit the frames higher than the previously received frames by one level, the transmitting end transmits the I-frame, B-frame and P-frame.

At step S408, the receiving end requests the transmitting end to transmit the frames lower than the previously received frames by one level. Referring to Table 1, it is assumed that the transmitting end has transmitted the I-frame and B-frame. If the receiving end requests the transmitting end to transmit the frames lower than the previously received frames by one level, the transmitting end transmits the I-frame and P-frame.

By performing the above-described process, the receiving end can reduce the amount of information being transmitted to the transmitting end. That is, the receiving end informs the transmitting end that the receiving end requests the frames of a higher level or a lower level only. Accordingly, the information that is requested to the transmitting end can be expressed by one bit only.

As described above, according to the present invention, a video signal can normally be reproduced even in a poor wireless environment by differently setting transport streams being transmitted from a transmitting end to a receiving end in a video reproduction system according to the state of a wireless environment. Additionally, by differently setting the transmitted transport streams according to the state of the wireless environment, data can be efficiently transmitted.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A frame transmission method performed by a transmitting end in a video reproduction system having the transmitting end for wirelessly transmitting frames and a receiving end for receiving the frames transmitted from the transmitting end and reproducing a video signal, the method comprising:
receiving information about a state of a wireless environment from the receiving end;
determining the frames to be transmitted to the receiving end in consideration of the received information about the state of the wireless environment; and
transmitting the determined frames to the receiving end.

2. The frame transmission method of claim 1, wherein the frames that can be transmitted to the receiving end comprise an I-frame, a B-frame and a P-frame.

3. The frame transmission method of claim 2, wherein if the state of the wireless environment is good, all of the I-frame, B-frame and P-frame are transmitted.

4. The frame transmission method of claim 2, wherein if the state of the wireless environment is poor, only the I-frame is transmitted.

5. The frame transmission method of claim 1, wherein if the frames to be transmitted refer to an analog signal, the analog signal is converted into a digital signal to be transmitted.

6. A video reproduction method performed by a receiving end using received frames in a video reproduction system having a transmitting end for wirelessly transmitting the frames and the receiving end for receiving the frames transmitted from the transmitting end and reproducing a video signal, the method comprising:
receiving the frames from the transmitting end;
measuring a state of a wireless environment by judging whether an error exists in the received frames and reproducing the video signal using the received frames; and
transmitting the measured state of the wireless environment to the transmitting end.

7. The video reproduction method of claim 6, wherein the transmitting the measured state of the wireless environment to the transmitting end comprises:
dividing a measurable state of the wireless environment into at least two sections; and
transmitting information about the at least two sections corresponding to the measurable state of the wireless environment to the transmitting end.

8. The video reproduction method of claim 7, wherein a number of sections is determined in consideration of the frames that can be transmitted by the transmitting end.

9. The video reproduction method of claim 6, wherein the transmitting the measured state of the wireless environment to the transmitting end comprises:
comparing a presently measured state of the wireless environment with a previously measured state of the wireless environment in a comparison; and
transmitting information about a result of the comparison to the transmitting end.

10. A video reproduction system having a transmitting end for wirelessly transmitting frames and a receiving end for receiving the frames transmitted from the transmitting end and reproducing a video signal, the system comprising:
a control unit configured to determine the frames to be transmitted to the receiving end in consideration of information about a state of a wireless environment from the receiving end;
an encoder configured to generate the frames to be transmitted in accordance with a control command from the control unit; and
a wireless transmission module configured to wirelessly transmit the generated frames.

11. The video reproduction system of claim 10, wherein the frames that can be transmitted to the receiving end are an I-frame, a B-frame and a P-frame.

12. The video reproduction system of claim 11, wherein if the state of the wireless environment is good, all of the I-frame, B-frame and P-frame are transmitted.

13. The video reproduction system of claim 11, wherein if the state of the wireless environment is poor, only the I-frame is transmitted.

14. The video reproduction system of claim 10, wherein if the frames to be transmitted refer to an analog signal, the control unit operates to convert the analog signal into a digital signal to transmit the digital signal.

15. A video reproduction system having a transmitting end for wirelessly transmitting frames and a receiving end for receiving the frames transmitted from the transmitting end and reproducing a video signal, the system comprising:
a wireless reception module configured to receive the frames from the transmitting end;
a wireless environment measurement unit configured to measure a state of a wireless environment by judging whether an error exists in the received frames;
a decoder configured to reproduce the video signal using the received frames; and
a control unit configured to transmit the measured state of the wireless environment to the transmitting end.

16. The video reproduction system of claim 15, wherein the control unit divides a measurable state of the wireless environment into at least two sections and transmits information about the at least two sections corresponding to the measurable state of the wireless environment to the transmitting end.

17. The video reproduction system of claim 15, wherein the control unit compares a presently measured state of the wireless environment with a previously measured state of the wireless environment in a comparison, and transmits information about a result of the comparison to the transmitting end.
